(19) United States
(12) Patent Application Publication
(10) Pub. No.: US 2026/0173171 A1
(43) Pub. Date: Jun. 18, 2026

(54) METHOD OF MANAGEMENT OF A REMOTE DEVICE, COMMUNICATION METHOD, MANAGEMENT SERVER, AND COMMUNICATION DEVICE

(71) Applicant: Orange, Issy-les-Moulineaux (FR)

(72) Inventors: Kevin L'Hereec, CHATILLON CEDEX (FR); Frederic Bour, CHATILLON CEDEX (FR); Valentin Baud, CHATILLON CEDEX (FR)

(21) Appl. No.: 19/422,116

(22) Filed: Dec. 16, 2025

(30) Foreign Application Priority Data
Dec. 17, 2024 (FR) 2414402

(51) Int. Cl. H04W 76/10; H04W 24/02

(52) U.S. Cl. CPC H04W 76/10; H04W 24/02

(57) ABSTRACT

A method of management of a remote device is described, the method implemented by a management server configured to manage said remote device via a routine management channel set up with the remote device. The method includes transmitting, to the remote device, via said management channel, a command to set up an occasional intervention channel having a latency lower than the latency of the management channel, and following set-up of said occasional intervention channel, transmitting at least one management command to the remote device via said occasional intervention channel.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### TECHNICAL FIELD

The disclosed technology generally relates to the field of communications between remote devices.

More precisely, the disclosed technology relates to a method for remotely managing a communicating device.

### BACKGROUND

Internet access relies on deployment of much network equipment: servers, DSLAMs (Digital Subscriber Line Access Multiplexers), routers, gateways, etc. Proper operation of this equipment involves various management, maintenance and sometimes troubleshooting actions. Such actions may, for example, correspond to updates of the computer systems (firmware) of this equipment, to the adjustment of their configuration parameters or even occasionally to the investigation of errors or performance of tests with a view to resolving malfunctions or failures.

Because of the varied nature of the pieces of network equipment to be managed, their number and location (and incidentally, potential difficulty in accessing this network equipment), it is necessary to use suitable communication protocols allowing remote interaction with this network equipment.

Thus, for example, the TR-069 protocol (or CPE WAN Management Protocol, as defined in the technical report “TR-069: CPE WAN Management Protocol” of the DSL Forum of May 2004) is frequently used in the context of management, from a wide area network, of equipment belonging to a local area network, such as routers or gateways for example, these often being referred to as “Internet boxes”.

This protocol is highly suitable particularly in this context, since it makes it possible to execute maintenance and updating operations on a high number of pieces of equipment in a secure manner while limiting the associated network costs.

However, the TR-069 protocol and similar protocols are not designed for real-time communications. In the case of one-off interventions such as troubleshooting or investigation of the causes of a malfunction of a piece of network equipment, this limitation may lead to a prolongation of the intervention time of technicians operating from a management server.

In order to remedy this problem, other so-called “real-time” protocols, such as for example the MQTT protocol (initially Message Queuing Telemetry Transport), may be used. However, these protocols, which have lower latency, require a permanent connection between the management server and the network equipment on which intervention is planned in order to maintain an active communication channel between them. While this allows near-instantaneous interaction, maintaining such a permanent connection may prove costly in terms of network resources, power consumption, and infrastructure management, especially when a large amount of network equipment requires intervention.

This constant connectivity requirement poses a particular challenge for network operators looking to optimize operational efficiency while managing expanding quantities of equipment.

As a result, such so-called “real-time” protocols, because of their cost and the amount of equipment to be managed, are not used to perform remote-configuration or diagnostic operations.

### SUMMARY

The disclosed technology in particular addresses the problem of finding a compromise between a network that is economical in terms of network cost and a network having a lower latency, by providing a method of management of a remote device, implemented by a management server configured to manage said remote device via a routine management channel set up with the remote device, said method comprising:
a step of transmitting, to the remote device, via said management channel, a command to set up an occasional intervention channel having a latency lower than the latency of the management channel,
following set-up of said occasional intervention channel, transmitting at least one management command to the remote device via said occasional intervention channel.

The disclosed technology also relates to a method of communication, implemented by a remote device communicating with a management server via a routine management channel, said method comprising:
a step of receiving, from said management server, via said routine management channel, a command to set up an occasional intervention channel having a latency lower than the latency of the management channel,
following set-up of the intervention channel, a step of receiving at least one management command from the management server via the intervention channel.

The disclosed technology advantageously makes it possible to overcome the limitations of prior-art management solutions based solely on the use of a communication protocol such as TR-069 or the like, and in particular their relatively high latency, by making it possible for the management server to use, when necessary or relevant, a communication channel having a lower latency and incidentally a greater responsiveness.

By significantly reducing transmission times when two devices must send each other a high number of requests and replies, each of these exchanges having a latency, the disclosed technology advantageously allows a technician required to intervene on one or more pieces of network equipment to make their interventions shorter. Consequently, it is possible for them to carry out more interventions in a given period of time.

Thus, the disclosed technology makes provision to use two channels for the management of remote equipment:
a routine management channel (below also called the first channel) used by default for many common operations, for example such as reporting usage information or updating internet gateways or routers via management servers. The routine management channel may typically employ remote-device management protocols such as TR-069 or a similar protocol; and
an occasional intervention channel (below also called the second channel) that has a greater responsiveness than the routine management channel at the expense of a higher cost in terms of network resources, but activation of which is one-off and exceptional.

The fact that the occasional intervention channel may require more substantial network resources (for example, because this channel requires a permanent connection to the server be kept active) is thus counterbalanced by the fact that its activation is, according to the disclosed technology, triggered occasionally, for example during a one-off troubleshooting or diagnostic operation.

According to one particular embodiment, the method of management of a remote device further comprises a step of detecting a given event triggering transmission, to the remote device, via said management channel, of the command to set up the occasional intervention channel.

No limitation is placed on the nature of the event triggering transmission of the set-up command. For example, this event may be opening, from the management server, a configuration panel associated with the remote network equipment or when a support technician enters, into a software package implemented by the management server, a reference number of a client associated with a remote device.

This embodiment advantageously makes it possible to make activation of an occasional intervention channel conditional upon a particular and preset triggering event, and therefore to reduce the risk of an increase in the network resources mobilized for unexceptional actions associated by default with the management channel used for routine management operations.

According to one particular embodiment of the communication method, set-up of the occasional intervention channel is conditional upon authentication of the set-up command received from the management server.

The authentication implemented for this embodiment may be an authentication according to the SSL/TLS protocol (SSL/TLS standing for Secure Socket Layer/Transport Layer Security) or according to any other protocol known to those skilled in the art.

This embodiment advantageously makes it possible to make the actions executed via the occasional intervention channel secure. For example, the authentication makes it possible to ensure that the remote device does not receive information that might interfere with its correct operation or, on the contrary, does not transmit sensitive information to an unauthorized management server.

Furthermore, implementation of an authentication prior to the command to set up the occasional intervention channel makes it possible to avoid unnecessary consumption of network resources in the event of a command to set up an intervention channel by an unauthorized management server.

According to one particular embodiment, the communication method further comprises a step of deactivating the occasional intervention channel after a period of time known to the remote device.

As a variant, the communication method further comprises a step of deactivating the occasional intervention channel at the end of a given period of idleness of said occasional intervention channel.

The value of this idle time may in particular be communicated when activation of the occasional intervention channel is requested. Optionally, the request to activate the second channel may be refused if no value for this idle time is declared or if the value declared is greater than a maximum time permitted by the remote device.

These embodiments advantageously make it possible to limit the power consumption and bandwidth consumption associated with the occasional intervention channel. Making this interruption automatic in the event of inactivity or making it conditional upon a given preset time allows the risk of keeping the occasional intervention channel activated too long and therefore of consuming an excessive amount of network resources to be limited. This embodiment also makes it possible to avoid the need for a specific command to interrupt the occasional intervention channel, this simplifying implementation of the disclosed technology.

According to one particular embodiment, the management method further comprises a step of transmitting a command to deactivate the occasional intervention channel to the remote device.

Correspondingly, according to one particular embodiment, the communication method further comprises a step of deactivating the occasional intervention channel on receipt of a command from the server.

This embodiment advantageously makes it possible to avoid cases where the occasional intervention channel is open for too long and where the network costs engendered by keeping it open are no longer compensated for by the advantages achieved in terms of its responsiveness and the lower latency of the messages exchanged with the management server.

According to one particular embodiment, the occasional intervention channel complies with the MQTT protocol.

Use of the MQTT protocol allows a near-instantaneous interaction between the management server and the remote device and therefore ensures lower latencies than the default communication channel used to communicate between the management server and the remote device.

Since maintaining connections according to the MQTT protocol between a high number of communication devices may prove costly in terms of network resources, the disclosed technology ensures recourse to such a protocol is only made occasionally.

According to one particular embodiment, the routine management channel complies with the TR-069 protocol, TR being the abbreviation of Technical Report.

The disclosed technology also relates to a management server configured to manage a remote device via a routine management channel set up with the remote device, comprising:
a transmitting module configured to transmit, to the remote device, via said management channel, a command to set up an occasional intervention channel having a latency lower than the latency of the management channel,
a managing module configured, following set-up of said occasional intervention channel, to transmit at least one management command to the remote device via said occasional intervention channel.

The disclosed technology also relates to a remote device capable of communicating with a management server via a routine management channel, said remote device comprising:
a receiving module, configured to receive, from said management server, via said routine management channel, a command to set up an occasional intervention channel having a latency lower than the latency of the management channel,
a receiving module, configured, following set-up of the occasional intervention channel, to receive at least one management command from the management server via the intervention channel.

The disclosed technology lastly relates to a communication system comprising:
a management server according to the disclosed technology,
a remote device according to the disclosed technology.

The disclosed technology also relates to a computer program comprising program code instructions for implementing the communication and management methods according to any of the particular embodiments described above, when said program is executed on a computer.

Such instructions may be stored durably on a non-transient memory medium of a communication terminal implementing the communication and management methods according to the disclosed technology.

This program may use any programming language, and take the form of source code, object code, or code intermediate between source code and object code, such as code in a partially compiled form, or in any other desirable form.

The disclosed technology also relates to a computer-readable information medium or recording medium including instructions of a computer program such as mentioned above.

The recording medium may be any entity or device capable of storing the program. For example, the medium may comprise a storage means, such as a ROM (read-only memory), for example a CD-ROM (compact disc read-only memory) or a microelectronic circuit ROM, or else a magnetic recording means, for example a mobile medium, a hard drive or an SSD (solid-state drive).

Moreover, the recording medium may be a transmissible medium such as an electrical or optical signal, which may be routed via an electrical or optical cable, by radio or by other means, such that the computer program which it contains may be executed remotely. The program according to the disclosed technology may, in particular, be downloaded from a network, the Internet for example.

Alternatively, the recording medium may be an integrated circuit into which the program is incorporated, the circuit being configured to execute or to be used in the execution of the abovementioned communication and management methods.

It is also possible, in other embodiments, to envision the communication and management methods and devices, and the communication system according to the disclosed technology, having all or some of the abovementioned features in combination.

### BRIEF DESCRIPTION OF THE DRAWINGS AND APPENDIX

Other features and advantages will become apparent upon reading particular embodiments of the disclosed technology, which are given by way of illustrative and non-limiting examples, and the appended drawings, in which:

FIG. 1 shows a communication system according to the disclosed technology in one particular embodiment,

FIG. 2 shows one example of a management server implementing the method of management of a remote device according to one embodiment of the disclosed technology,

FIG. 3 shows one example of a remote device implementing the communication method according to one embodiment of the disclosed technology,

FIG. 4 illustrates the steps of the communication and management methods according to one embodiment.

The appendix presents commands in the Python® language that may be used by the remote device.

### DETAILED DESCRIPTION

### Exemplary Architecture

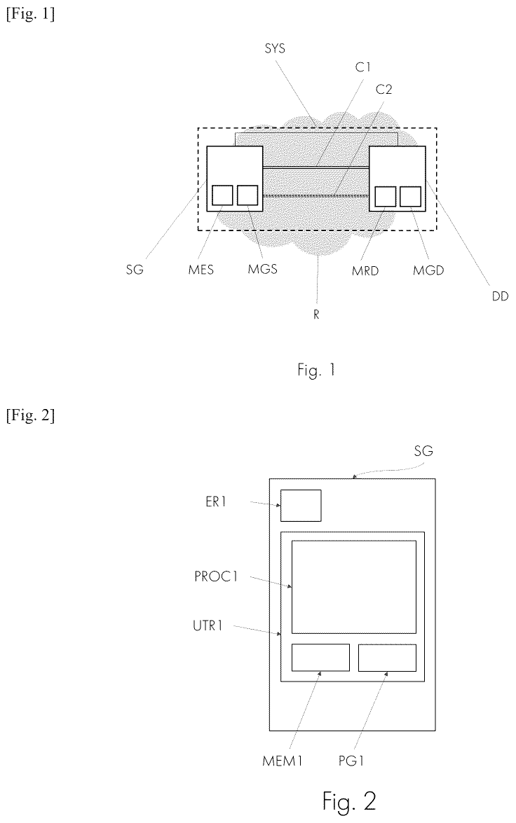

FIG. 1 shows a communication system within which may be implemented the communication and management methods according to the disclosed technology in one particular embodiment.

This system comprises:
a management server SG according to the disclosed technology. The server SG may be a dedicated server or any other device performing similar management operations (a computer, a DSLAM, a computer associated with an application allowing maintenance of remote equipment, etc.); and
at least one remote device DD according to the disclosed technology, for example such as a gateway, NAS (Network Attached Storage), a router or any other remote device capable of being managed by the server SG.

The server SG and said at least one remote device DD communicate by virtue of a communication network R. This network allows them to exchange information with one another, in particular in the context of the disclosed technology. In this embodiment, the network R is a fiber network; however, alternatively, it may be a question of any communication network known to those skilled in the art.

In the example illustrated in FIG. 1, for the sake of simplicity, a single remote device DD is considered. However, the management server SG may be configured to manage a plurality of remote devices in a similar or identical manner to the one described here in respect of the remote device DD.

In the example envisioned here, the management server SG corresponds to the type of device management system commonly referred to as an ACS (abbreviation of Auto-Configuration Server). This type of server is in particular used for remote management, for configuration and for monitoring of devices such as routers, residential gateways and IoT devices (IoT standing for Internet of Things). However, the management server may correspond to any other type of system or server known to those skilled in the art. In a manner known per se, the management server SG communicates with the remote device DD, in order to carry out such remote management operations, configuration operations and/or monitoring operations, via a first communication channel C1, called the default communication channel or routine management channel, this channel using a given communication protocol.

In the example envisioned here, the routine management channel complies with the management protocol TR-069. However, as a variant, it may also be a question of a communication channel compliant with any other CoaP management protocol or any other protocol known to those skilled in the art.

According to the disclosed technology, the remote device DD and the management server SG may also communicate occasionally via a second communication channel C2, called the occasional communication channel or the occasional intervention channel, using a given protocol different from the management protocol used by the default communication channel C1 and having a lower latency.

In the example envisioned here, the occasional intervention channel C2 complies with the MQTT protocol.

However, as a variant, it may also be a question of a communication channel complying with the AMQP protocol or using KAFKA message buses or with any other protocol known to those skilled in the art, provided that it has a latency lower than the latency of the routine management channel.

According to the disclosed technology, the management server SG is equipped with:
a transmitting module MES, and
a managing module MGS.

The remote device DD for its part is equipped with:
a receiving module MRD,
a receiving module MGD.

The various functional modules of the management server SG and of the remote device DD will be described below in greater detail.

FIG. 2 shows, in a simplified manner, the structure of the management server SG configured to implement the management method according to the disclosed technology, in one particular embodiment.

In the particular embodiment of the disclosed technology described here, the steps executed by the management server SG are implemented by means of instructions of a computer program PG1. To that end, in the embodiment described here, the management server SG has the conventional architecture of a computer and in particular comprises a transceiving module ER1, a memory MEM1, and a processing unit UTR1, equipped for example with a processor PROC1, and driven by the computer program PG1 stored in the memory MEM1. The memory MEM1 is a recording medium within the meaning of the disclosed technology.

As mentioned above, the computer program PG1 comprises instructions for implementing the steps of the management method according to the disclosed technology, which steps are described below with reference to [FIG. 4]. It thus defines functional modules of the server SG that comprise:
the transmitting module MES configured to transmit, to the remote device, via the management channel C1, a command to set up the occasional intervention channel C2 having a latency lower than the latency of the management channel C1,
the managing module MGS configured, following set-up of said occasional intervention channel C2, to transmit at least one management command to the remote device via said occasional intervention channel C2.

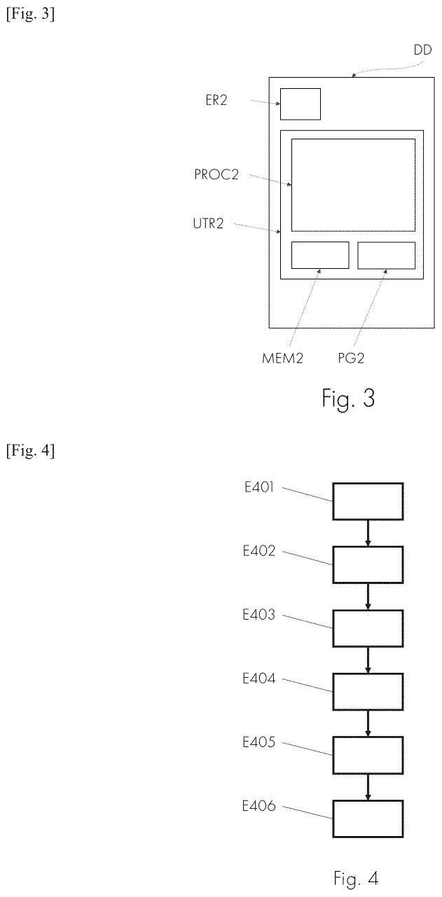

FIG. 3 shows, in a simplified manner, the structure of the remote device DD configured to implement the communication method according to the disclosed technology, in one particular embodiment.

In the particular embodiment of the disclosed technology described here, the steps executed by the remote device DD are implemented by means of instructions of a computer program PG2. To that end, the device DD has the conventional architecture of a computer and in particular comprises a transceiving module ER2, a memory MEM2, and a processing unit UTR2, equipped for example with a processor PROC2, and driven by the computer program PG2 stored in the memory MEM2. The memory MEM2 is a recording medium within the meaning of the disclosed technology.

As mentioned above, the computer program PG2 comprises instructions for implementing the steps of the communication method according to the disclosed technology, which steps are described below with reference to [FIG. 4]. It defines functional modules of the remote device DD that in particular comprise:
the receiving module MRD, configured to receive, from said management server, via said routine management channel C1, a command to set up the occasional intervention channel C2,
the receiving module MGD, configured, following set-up of the occasional intervention channel C2, to receive at least one management command from the management server via this occasional intervention channel C2.

### Exemplary Steps of Communication and Management Methods.

FIG. 4 illustrates the steps of the communication and management methods according to the disclosed technology in one particular embodiment in which the methods are respectively implemented by the management server SG and the remote device DD.

As described above, it is assumed that, in a prior step (not shown in FIG. 4), the routine management channel C1 is set up between the management server SG and the remote device DD. This communication channel C1 is used to allow exchanges between the management server SG and the remote device DD (these in particular including transmission of management commands by the management server SG) in the context of routine remote-management operations, for example such as updates to the remote device DD or retrieval by the management server SG of usage data from the device DD.

However, in the context of an occasional management operation, using an occasional intervention channel having a lower latency is considered preferable to using said routine management channel.

In the example envisioned here, the communication and management methods allowing an occasional intervention channel to be set up are initiated following a given event, for example such as opening, from the management server and with a view to urgent troubleshooting, an occupational application referencing an identifier corresponding to the remote device (for example such as a client number attached to the remote device or an IP address, etc.).

However, alternatively, the communication and management methods, allowing an occasional intervention channel to be set up, are implemented when a management and/or intervention operation justifies, for example from the point of view of an intervening technician or of a support supervisor, recourse to an occasional intervention channel.

Thus, in E401, the management server SG transmits, to the remote device DD, via the routine management channel C1, a command to set up an occasional intervention channel C2.

Recourse to this occasional intervention channel C2 is exceptional and is intended only for a given number of management operations for which, because of its lower latency and despite its additional cost in terms of network resources, use of the intervention channel is justified in view of given constraints. For example, it may be a question of the importance of a fault to be addressed, of the work time allocated to a technician for a type of intervention, etc.

According to this example, transmission of the set-up command is automatically triggered following a given event, for example such as opening, from the management server, an occupational application referencing an identifier corresponding to the remote device (for example such as a client number assigned to the remote device or an IP address, etc.) or any other event.

In the embodiment described here, the command to set up the channel C2 results in the remote device DD triggering a server REST embedded in the remote device serving as an activation point for an MQTT client.

The command to set up an occasional intervention channel C2 by the remote device DD also includes, in the embodiment described here, a datum allowing the remote device to authenticate the management server SG.

By way of example (drawn from the appendix), a request allowing secure activation (i.e. the set-up command within the meaning of the disclosed technology) of the channel C2 according to the real-time MQTT protocol may take the following form:

```
curl -X POST “$DD_URL” \
-H “Authorization: Bearer $AUTH_TOKEN” \
-H “Content-Type: application/json” \
-d ‘{
  “action”: “set up_channel”,
  “protocol”: “MQTT”
}’
```

In this example, a basic authentication is employed. The parameter AUTH_TOKEN is an authentication datum known to the remote device and to the server.

As a variant, an authentication according to OAUTH2.0 protocols or an authentication based on X.509 certificates or any other type of authentication known to those skilled in the art may be implemented.

In E402, the remote device DD receives from the management server SG, via the default communication channel C1, the command to set up an occasional intervention channel C2.

In this embodiment, the remote device authenticates the management server SG from which the set-up command (or request) originates. If the management server SG is listed as a server authorized to transmit a command of this type to the remote device DD, the communication and management methods continue, otherwise the methods terminate.

The information stating whether the management server is authorized to transmit a command to set up an occasional intervention channel is for example declared beforehand in a configuration file or in a database internal to the remote device DD or accessible by the latter from a third-party device that has not been shown (for example, a remote computer or server).

In E403, the remote device DD sets up an occasional intervention channel (or second communication channel) C2 with the management server SG.

According to this embodiment, a server REST embedded in the remote device is used to activate an MQTT client in order to set up said occasional intervention channel.

Alternatively, the occasional intervention channel may use any other client corresponding to another communication protocol suitable for such an occasional intervention and known to those skilled in the art.

In E404, the remote device DD transmits a request to connect to the occasional intervention channel C2 to the management server SG.

By way of example drawn from the appendix, a prompt to set up an MQTT connection via login/password to an MQTT client may take the following form in the Python® language:

# Credentials
username = “your_username”
password = “your_password”
# Connection to the broker with authentication
client.username_pw_set(username, password)
client.connect($SG_BROKER_URL, 1883, 60)
““ $SG_BROKER_URL being one example of an address
allowing connection to the management server ””
# Loop allowing message processing
client.loop_start( )

In E405, after having accepted the request to connect to the MQTT client, the management server SG transmits at least one management command to the remote device DD via the occasional intervention channel C2.

In the example envisioned here, the channel C2 is used to exchange data relating to the abovementioned troubleshooting intervention. Alternatively, the occasional intervention channel C2 is used for specific (i.e. non-routine) diagnostics, troubleshooting or parameterization of the remote device or for any other intervention that would be considered relevant by a person skilled in the art.

According to this embodiment, the communication channel C1 may continue to be used, in parallel with the occasional intervention channel C2, to route data relating to routine management operations.

To increase security, the server REST used to trigger the MQTT client moreover implements strict authentication and authorization mechanisms, ensuring that only messages originating from the management server are accepted, thus preventing any unauthorized activation of the MQTT client.

This authentication mechanism is based on the same information used in E402 to verify that the management server is authorized to transmit a command to set up an occasional intervention channel. Alternatively, the server REST implements a separate authentication mechanism, for example such as (by default) HTTPS (Hypertext Transfer Protocol Secure) with 2-way TLS (Transport Layer Security), i.e. with mutual identification of the client certificate and server certificate achieved through inclusion, between the server and the client, of a proxy that performs the basic access authentication.

According to another example, it is also possible, in addition, to define a URL path with a communication-channel endpoint including an encrypted identifier known only to the server.

In E406, once the data have been exchanged, the occasional intervention channel C2 is deactivated.

In the embodiment described here, the occasional intervention channel C2 is configured to be deactivated after a predefined time known to the remote device DD. This predefined time is declared beforehand to the remote device, for example during implementation of the operating system of the remote device or at the end of a prior configuration step of the device carried out beforehand.

According to another embodiment, the occasional intervention channel C2 is configured to be deactivated after an idle time, i.e. after no message has been routed over the occasional intervention channel for a given time. In the same way, the value of this idle time of the second channel is declared during initialization of the remote device or declared upstream of the implementation of the methods.

According to another embodiment, the occasional intervention channel is configured to be deactivated after a given time by the management server. It may for example be a question of a connection time parameterized during the request to set up the occasional intervention channel C2 or during a specific command or even via a command to close the occasional intervention channel sent by the management server SG at the end of a given time, this time possibly being declared beforehand, to the server or application used, by the management server that triggered the request to set up the occasional intervention channel.

According to yet another embodiment, the occasional intervention channel is deactivated by the remote device after receipt of a deactivation command transmitted by the server.

By way of example drawn from the appendix, a prompt by the remote device to deactivate the MQTT channel may take the following form in the Python® language:

client.loop stop( )
client.disconnect( )

In conclusion, the disclosed technology advantageously allows, according to the embodiment described here, an intervening technician or any other person skilled in the art to intervene on a remote device via the communication channel most suited to the urgency of the situation.

According to this embodiment, the technician, or any other person skilled in the art, may use the communication and management methods iteratively each time a particular intervention or management action requires, in their opinion, a communication channel having a lower latency than the latency of the routine management channel.

The methods described here in the context of network equipment may also be applied, generally, to any connected object that it is sought to manage remotely.

### APPENDIX

Example of commands, in the Python® language, that may be implemented by the MQTT client in the remote device or in the management server:

```
import paho.mqtt.client as mqtt
# Callback for connection
def on_connect(client, userdata, flags, rc):
  print(“Connected with the result code: ” + str(rc))
  # Subscribe to a topic after connection
  client.subscribe(“example/topic”)
# Callback for receipt of messages
def on_message(client, userdata, msg):
  print(f“Message received on {msg.topic}:
{msg.payload.decode( )}”)
# Create an MQTT client
client = mqtt.Client( )
# Define the callbacks
client.on_connect = on_connect
client.on_message = on_message
# Credentials
username = “your_username”
password = “your_password”
# Connection to the broker with authentication
client.username_pw_set(username, password)
client.connect(“broker.hivemq.com”, 1883, 60) # Replace
with the address of your broker
# Loop allowing message processing
client.loop_start( )
# Publish a message on a topic
client.publish(“example/topic”, “Hello, MQTT!”)
# Keep the script running
import time
time.sleep(10)
# Disconnection
client.loop_stop( )
client.disconnect( )
```

1. A method of management of a remote device, implemented by a management server configured to manage said remote device via a routine management channel set up with the remote device, said method comprising:
transmitting, to the remote device, via said management channel, a command to set up an occasional intervention channel having a latency lower than the latency of the management channel, and
following set-up of said occasional intervention channel, transmitting at least one management command to the remote device via said occasional intervention channel.

2. The method of claim 1, further comprising detecting a given event triggering transmission, to the remote device, via said management channel, of the command to set up the occasional intervention channel.

3. The method of claim 1, further comprising transmitting a command to deactivate the occasional intervention channel to the remote device.

4. A method of communication, implemented by a remote device communicating with a management server via a routine management channel, said method comprising:
receiving, from said management server, via said routine management channel, a command to set up an occasional intervention channel having a latency lower than the latency of the management channel, and
following set-up of the intervention channel, receiving at least one management command from the management server via the intervention channel.

5. The method of claim 4, wherein set-up of the occasional intervention channel is conditional upon authentication of the set-up command received from the management server.

6. The method of claim 4, further comprising deactivating the occasional intervention channel after a period of time known to the remote device.

7. The method of claim 4, further comprising deactivating the occasional intervention channel at the end of a given period of idleness of said occasional intervention channel.

8. The method of claim 4, further comprising deactivating the occasional intervention channel on receipt of a command from the server.

9. The method of claim 4, wherein the occasional intervention channel complies with the Message Queuing Telemetry Transport (MQTT) protocol.

10. The method of claim 4, wherein the routine management channel complies with the TR-069 protocol, TR being an abbreviation of Technical Report.

11. A management server configured to manage a remote device via a routine management channel set up with the remote device, said management server comprising a processor configured to set up the method of claim 1.

12. A remote device capable of communicating with a management server via a routine management channel, said remote device comprising:
a receiving module configured to receive, from said management server, via said routine management channel, a command to set up an occasional intervention channel having a latency lower than the latency of the management channel,
a receiving module configured, following set-up of the occasional intervention channel, to receive at least one management command from the management server via the intervention channel.

13. A communication system comprising:
the management server of claim 11, and
the remote device capable of communicating with the management server via the routine management channel, said remote device comprising:
a receiving module configured to receive, from said management server, via said routine management channel, the command to set up an occasional intervention channel having a latency lower than the latency of the management channel, and
a receiving module configured, following set-up of the occasional intervention channel, to receive at least one management command from the management server via the intervention channel.
